(19) United States
(12) Patent Application Publication
(10) Pub. No.: US 2006/0207235 A1
(43) Pub. Date: Sep. 21, 2006

(54) Mower handlebar-attachable string trimmer wand

(75) Inventors: Jason S. Izatt, American Fork, UT (US); Justin C. Yarro, Provo, UT (US)

Correspondence Address: EVERETT D. ROBINSON;Parsons Behle & Latimer, 201 South Main Street, Suite 1800, Salt Lake City, UT, 84145-0898, US

(73) Assignee: Trimmerwand, LLC

(21) Appl. No.: 11/376,021

(22) Filed: Mar. 15, 2006

Related U.S. Application Data
(60) Provisional application No. 60/662,422, filed on Mar. 16, 2005.

(51) Int. Cl. A01D 34/00

(52) U.S. Cl. 56/13.7

(57) ABSTRACT

The inventions relate generally to devices for trimming grass, such as string trimmers, that are attachable to a lawn mower and usable while mowing a lawn. More particularly, the inventions relate to a light-duty string trimmer wand attachable to a walk-behind lawn mower and independently operable to trim small areas of grass. Detailed information on various example embodiments of the inventions are provided in the Detailed Description below, and the inventions are defined by the appended claims.

### CROSS REFERENCE TO RELATED APPLICATIONS

This Application claims the benefit of the U.S. Provisional Application Ser. No. 60/662,422 filed Mar. 16, 2005 (hereinafter “the Provisional Application”) which is hereby incorporated by reference in its entirety.

### BACKGROUND OF THE INVENTIONS

A conventional homeowner lawn maintenance solution includes a push or walk-behind mower and a full-size string trimmer. The homeowner mows the accessible areas of the grass with the mower, however there are some areas the mower cannot reach, which are typically alongside fences and objects surrounded by grass. Following mowing, a typical homeowner stows the mower and takes up a string trimmer to tidy these inaccessible areas.

An ordinary, full-size string trimmer is designed to trim large areas of grass. For example, a homeowner having grass planted abutting a fence may trim the grass at the fence by sweeping the full-size trimmer generally along the length of the fence. While the homeowner has the trimmer out, he will trim central areas around trees, poles, flowerbeds and the like. Commonly, a string trimmer will be designed and marketed to trim not only small patches of relatively short grass, but also to clear weeds and tall grass. For this, a typical full-size string trimmer includes a relatively large power plant to drive its string through thick stems, leaves and cut debris while continuing to rotate its head at an acceptable speed. These power plants are conventionally either two-cycle combustion engines or electric motors.

A number of years ago string trimmers were commonly electric, connectible to ordinary AC power through an extension cord. The homeowner dragged the cord with him as he went, but that was preferable to trimming the grass by hand. This burden was relieved somewhat by the availability of portable gas-powered string trimmers, but due mainly to the size and weight of the engine required these are not comfortably used or carried in tandem with other yard-care equipment. Gas-powered trimmers also require some maintenance, mainly in relation to fuel replenishment and engine care.

One additional homeowner burden introduced by conventional string trimmers is that of making two passes across the yard: one to mow and one to trim. Some attempts have been made to combine a mowing operation with a trimming operation, generally by incorporating a string trimmer into a lawn mower powered thereby. Of these, many incorporate a trimmer head fixed to a mower deck, such as that described in U.S. Pat. No. 4,170,099 to Owens. Mowers of that type might be conveniently used near fences, as the operator would likely pass alongside a fence anyway. However, for trimming around small objects such a mower would need to be moved from side to side, which would require maneuvers against the generally forward mower motion for which it is principally designed. Solutions of this kind also introduce new moving parts and maintenance issues, and although several examples of solutions of this type have appeared in issued patents, mowers that incorporate a string trimmer have not attained popularity perhaps for these reasons.

Other designs have incorporated a string trimmer to a lawn mower, not fixably mounted. For example, U.S. Pat. No. 4,242,855 to Beaver describes a string trimmer powered through a flexible shaft coupled to the mower engine's crankshaft. Apparently, there are few solutions to providing driving power to a portable string trimmer head from a mower engine, and thus these designs appear infrequently. Furthermore, it seems likely that maintenance issues would outweigh the advantages; a flexible shaft would rotate at a fairly high rate and could suffer from cable breaks due to kinking or loss of lubricant over seasonal use.

Other aspects of combining a lawn-mower with a string trimmer have challenged prior designers. Most, if not all, of the prior designs incorporate essentially a full-sized trimmer or trimmer head as described above. Thus one might categorize the prior designs as either a string-trimmer head mounted to a mower deck, or a full-sized trimmer mounted to a riding mower/tractor such as that described by Aldrich in U.S. Pat. No. 5,802,824. Although many of the riding mower designs incorporate a fixed trimmer on a mower base, Aldrich cleverly adds removability of his trimmer for use apart from the riding mower. Aldrich's solution, however, is not suitable for the majority of homeowners who occupy a lot size of well less than one-half acre and do not have a substantial outbuilding large enough to store a riding mower. Thus in order to serve the majority of homeowners, a trimming product must be combinable with a walk-behind self-propelled or push mower.

For a homeowner with large areas of fence line to trim, use of a full-sized string trimmer may be acceptable. For him, the inconveniences of equipment care and the additional time to stow his mower and retrieve a string trimmer may be compensated with the efficiency with which his full-sized trimmer trims his many areas not reachable by his mower. However, there are some homeowners who have little trimming to do. Lawn areas abutting a sidewalk, driveway or other flat surface level with the lawn can be entirely cut by passing the mower over the lawn interface, although some seasonal edging may be required. Some homeowners deliberately place such mow-strips under fences to permit the mower to ride on the strip on one side, while preventing grass from growing directly under a fence. Traditionally, homeowners have also edged their grass with objects buried partially in the ground, providing a barrier to the expansion of grass. These objects have often had a substantial vertical profile, preventing a lawn mower to pass over these edges without substantial damage. Recently a product has become available that provides both an edging and a mow strip in the same block, and can be used to surround flowerbeds, trees or placed alongside fences to provide a mow strip and reduce or eliminate the need to trim grass.

A homeowner utilizing mow-strips, blocks and other products may have very few areas to trim, which might be reduced to the area around a few trees, or the legs on a child's swing set. For such a homeowner prior grass trimmers become cumbersome.

### BRIEF SUMMARY OF THE INVENTIONS

The inventions relate generally to devices for trimming grass, such as string trimmers, that are attachable to a lawn mower and usable while mowing a lawn. More particularly, the inventions relate to a light-duty string trimmer wand attachable to a walk-behind lawn mower and independently operable to trim small areas of grass. Detailed information on various example embodiments of the inventions are provided in the Detailed Description below, and the inventions are defined by the appended claims.

### BRIEF DESCRIPTION OF THE DRAWINGS

FIG. 1 depicts a first exemplary trimmer wand.

FIG. 2 depicts the internal components of the first exemplary trimmer wand.

FIG. 3A shows an assembled first exemplary interlock.

FIG. 3B shows an exploded view of the first exemplary interlock.

FIGS. 4A and 4B depict the coupled state of the first exemplary trimmer wand and the first exemplary interlock.

FIG. 5A depicts the first exemplary trimmer wand mounted to a walk-behind lawn mower by way of the first exemplary interlock.

FIG. 5B depicts the operation of the first exemplary trimmer wand.

FIG. 6 depicts an alternative exemplary sabre form of a trimmer wand.

FIG. 7A depicts a second exemplary interlock in exploded view.

FIG. 7B depicts the second exemplary interlock in an open or unclamped state.

FIG. 7C depicts the second exemplary interlock in a closed or clamped state.

FIG. 8A depicts a third exemplary form of a trimmer wand.

FIG. 8B depicts the third exemplary trimmer wand in exploded view.

FIGS. 9A and 9B show a non-spooling, threading rotating head and a section of trimmer string threaded in operational condition.

FIG. 10 depicts an exemplary guard that may be used with some trimmer wands.

FIG. 11A depicts an exemplary retractable guard in an extended position.

FIG. 11B depicts an exemplary retractable guard in a retracted position.

Reference will now be made in detail to some embodiments of the inventions, examples of which are illustrated in the accompanying drawings.

### DETAILED DESCRIPTION

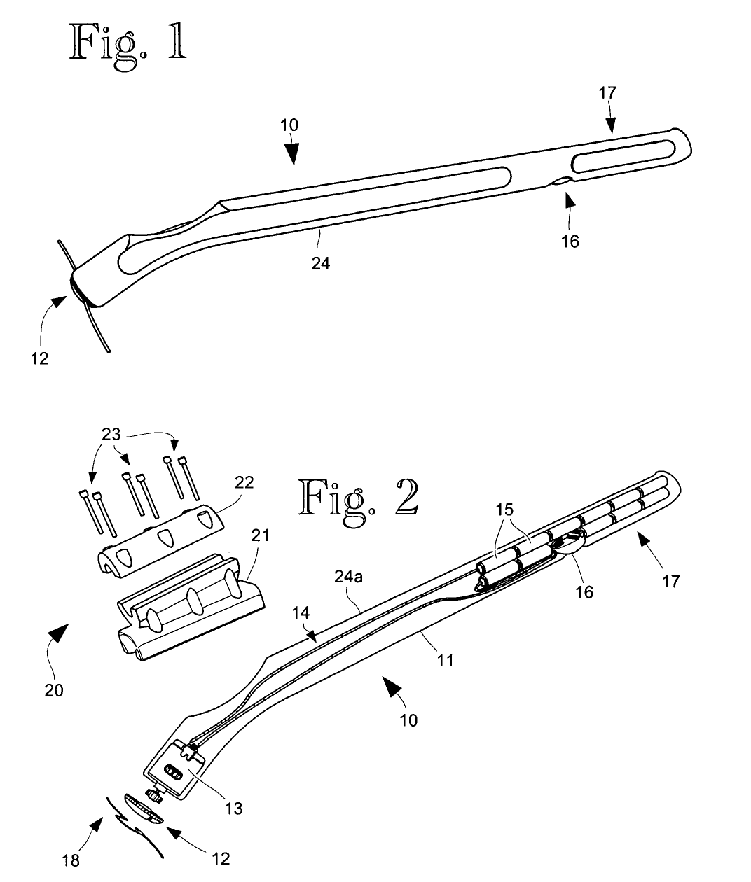

Disclosed herein are trimmer products attachable to a push mower, the first example of which is shown in FIG. 1. The trimmer products disclosed herein may be referred to as a wand, as generally these products are small and light enough to operate comfortably with one hand. The first exemplary wand 10 shown in FIG. 1 includes a body or housing 24, a grasping portion or handle 17, and a rotating head 12 distally disposed from the handle 17. Also in wand 10, head 12 is maintained at an angle relative to handle 17 to provide for a comfortable manual grip while maintaining head 12 level to the ground and away from the operator's body. Wand 10 is operated on or off through pressure on switch 16, which in this example is located at the underside of housing 24 at about the position of contact of an operator's index finger. In an alternative configuration, housing 24 at handle 17 may incorporate a flexible area over a switch, thereby closing the circuit while an operator applies squeezing pressure to the handle.

FIG. 2 depicts the internal components of exemplary wand 10 and its attachment bracket interlock 20. Housing 24 separates into two halves, one of which 24a is shown. Wand 10 incorporates an electric motor 13, the output shaft of which is attachable to rotating head 12, the shaft of which thereby is directly coupled to head 12. The housing of motor 13 attaches to or communicates with housing 24 and thereby rotates head 12 with respect to housing 24 when power is applied. Motor 13 is electrically connected to batteries 15, affixed to housing 24 inside or otherwise, through wires 14 that run the length of housing 24; motor 13 is interruptably controllable through switch 16 thereby controlling powered rotation of head 12. Motor 13 may be permanently or semi-permanently mounted to one of the housing halves to maintain position on disassembly of the wand. Housing portion 24a may include clips or other attachments holding wires 14 in position, easing assembly of the wand and also reducing vibrations and thereby wear. In exemplary wand 10 batteries 15 are positioned near grasping area 17, reducing the lever-arm of the working end of the product relative to the hand of an operator and thereby improving control. Batteries 15 may be selected to be a common type, such as a 1.2 to 1.5 volt dry cell battery. Batteries 15 maybe disposable types, alkaline or otherwise. Batteries 15 may also be a rechargeable type, such as NiMH or NiCd, and terminals may be provided in housing 24 to engage a charging circuit if desired. Also in FIG. 2, a length of trimmer line, which may be of the ordinary nylon type for string trimmers, is attachable to rotating head 12 through a threading operation, described hereinafter.

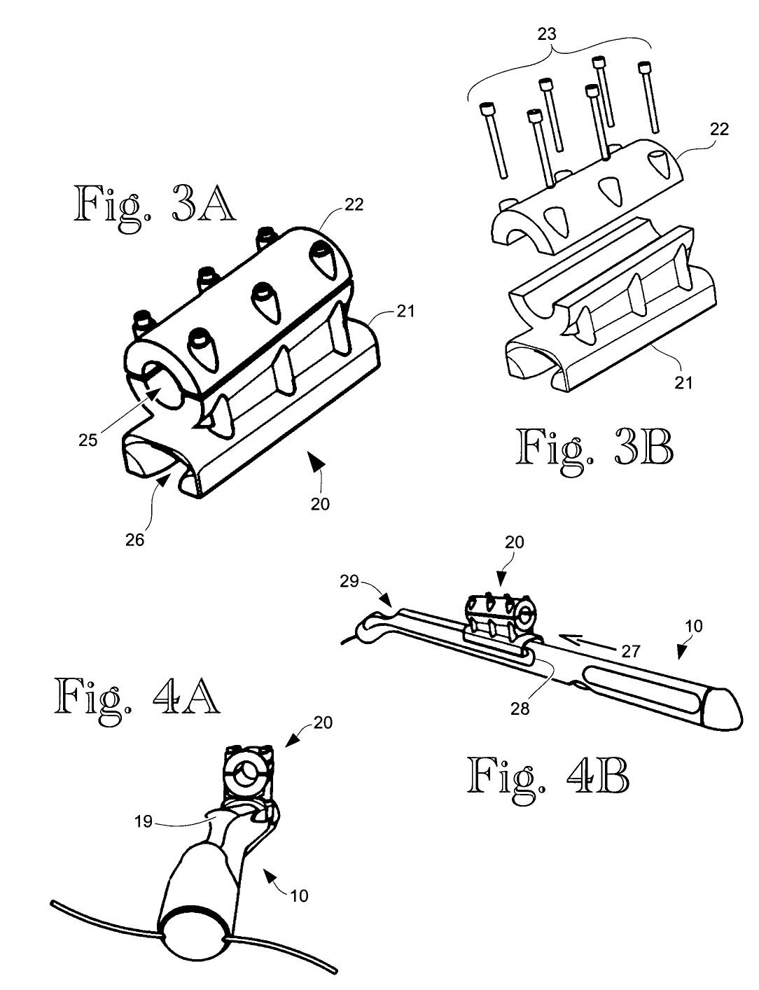

The exemplary trimmer wand 10 is designed to be attached to the tubular portion of a walk-behind mower handle, and wand 10 can be coupled to a mount securable to a tubular handle, which in this example is by a clamping interlock 20. Best viewed in FIGS. 3A and 3B, interlock 20 includes two halves 21 and 22, which together form a cylindrical channel 25 through which a steel handle tube may pass through. In this example, halves 21 and 22 are clamped by machine screws 23, although other arrangements maybe used as discussed below. Interlock 20 further includes a coupling channel 26 receiving housing 24. Referring now to FIG. 4A and further in this example, the shape of housing 24 includes a keyed portion 19 shaped to fit closely in channel 26. The profile of the key expands outward, thereby restraining the keyed portion 19 from exiting channel 26 and thereby forming a keyed interlock. As best viewed in FIG. 4B, housing 24 includes a widening key termination 28 preventing interlock 20 from moving beyond a resting position. Housing 24 may escape interlock 20 by a sliding motion through channel 26 downward 27 beyond key termination 29. A keyed coupling is but one example, and other coupling types may also be used. Looking again to FIG. 3A, the end of channel 26 is flared to ease alignment of housing 24 into channel 26. Keyed channel 26 and cylindrical channel 25 may be made symmetrical, which allows the interlock 20 to be installed in either direction on the tubular handlebar and thereby providing goof-proof installation for non-mechanically inclined homeowners. Alternatively as shown in figure SA, channel 26 may be angled with respect to channel 25 to set the grasping end of the wand at some distance from a mower handle providing clearance for a control lever or other handlebar-attached part.

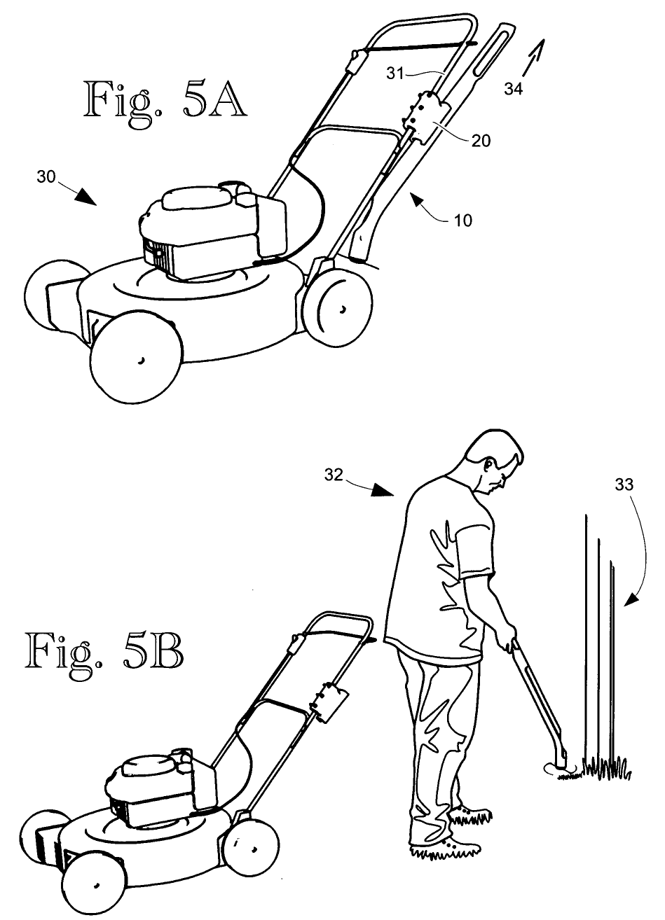

Use of the trimmer wand 10 and interlock 20 is depicted generally in FIGS. 5A and 5B in relation to a walk-behind push mower 30 including a mower deck, engine, cutting blade and handle 31. First in FIG. 5A, interlock 20 is clamped to handlebar 31 as described above. As shown, clamp 20 is attached on handlebar 31 to position trimmer wand 10 at the side of the handle 31, with wand 10 positioned generally below interlock 20 and the downward sloping side portion of handle 31. This position may serve to reduce interference with the movements of the lawn mower operator, and conveniently places the grasping portion near the operator. This position may also avoid interference with lawn mower controls, which are commonly mounted above the handle for the operator's convenient reach. Even so, interlock 20 may be positioned at other locations on handle 31 if desired.

As the operator 32 mows his lawn he may encounter an obstruction 33, which might in this drawing be a post, which prevents the mower 30 from cutting the grass nearby the obstruction. Momentarily, the operator stops the motion of mower 30, which may or may not involve stopping its engine. Operator 32 then withdraws wand 10 from interlock 20 by lifting it generally in the direction marked 34, or by pulling generally toward the operator standing behind mower handle 31. Operator 32 grasps the wand 10 and depresses switch 16 activating rotation of head 16 and thereby trimming around post 33. Note that because wand 10 is powered internally, it operates independently of mower 30 without any connection to the mower required. The length of wand 10 may be made to be approximately 30 to 38 inches, placing head 12 at a comfortable level with respect to the ground when held out at an angle and away from the operator's body. When finished, operator 32 replaces wand 10 back into interlock 20, in this configuration also by a sliding motion, and continues to mow as before. Note that because wand 10 is available to the operator 32 when an obstacle 33 is encountered, he need not move from the immediate vicinity of lawn mower 30 to trim the grass around the obstacle.

Now the use of the exemplary wand 10, or others disclosed herein, provides several benefits. First, as most walk-behind mowers incorporate a tubular handle, a wand can be added as an attachment to virtually all walk-behind mowers. Because the wand is relatively small, it may be stored beneath a typical walk-behind lawn mower handle, and no additional storage space in a garage or shed is needed. Additionally, the weight of the wand can be reduced to the point that the wand can be controlled with one hand. If a homeowner can operate a trimming wand with one hand, he can keep a safety control lever depressed with the other and potentially avoid restarting his lawn mower while trimming. A typical walk-behind lawn mower weighs about 70 to 100 lbs., and a wand weighing about 5 lbs. or less is comparatively light and is not likely to be an encumbrance to a lawn mower operator. With careful choice of a motor, batteries and other components, a wand might be constructed weighing about two to three lbs or even less.

The components of the wand contributing the most to the weight are the batteries and motor, as the housing and other components can be made from plastics or other light-weight materials. The housing of a wand can also be constructed with thinner walls, due to its lighter-duty requirements. In one implementation, a wand is constructed having about a 2 cm diameter with walls about 2 mm in thickness, permitting AA size batteries to be housed therein.

A wand may utilize a DC motor having a sufficient torque and rotational speed for the desired use. One implementation utilizes an HC783LG or similar motor available from Johnson Electric of Tai Po, Hong Kong (www.johnsonelectric.com), having a speed of about 14,000 to 16,000 RPM at a current of about 1.8A at 12 V and no load. Alternatively, a Stinger motor manufactured by Traxxas of Plano, Tex. (www.traxxas.com), requiring 1.2 A at 12 V and rotating at 17,500 RPM may also be used. A motor in the Havoc line from Team Orion of Yorba Linda, Calif. (www.teamorion.com) is also a suitable choice. A rotational speed of about 10,000 to 20,000 RPM may provide good performance: a high RPM or high power motor may provide improved trimming efficiency although depleting batteries more quickly. Should a high-current motor be chosen, it may be necessary to provide venting in the housing near the motor. Generally, motors manufactured for remote-controlled cars or boats are suitable due to their high power and/or speed and light weight, which may be under 2 lbs. If desired, a motor may be placed toward the handle portion through the use of a straight or geared shaft coupled to the motor, which may improve the balance of a wand by moving the center of gravity toward the handle. Also, a wand housing might be made to fit motor magnets, armatures, contacts and other parts, taking the place of an independent motor housing and potentially reducing weight and/or cost.

As suggested above, dry cell batteries are an acceptable choice for some applications. For the 12V Johnson motor above, it may be useful to use 8 or 9 C or D cells providing up to several hours of use per charge. In such a configuration, it may be expected that a set of batteries might last sufficiently long for some users to make battery replacement a start-of-the-season maintenance activity. AA cells might also be acceptable if a lower-current motor is used. Other battery configurations may be used consistent with the desired portability and use of the trimmer product. With the use of C size batteries and a motor as suggested above, a wand could weigh as little as five or six lbs and not encumber an operator's control of a lawn mower to which it may be attached. With AA size batteries, a further weight reduction could be made at the expense of available current for the motor and battery life.

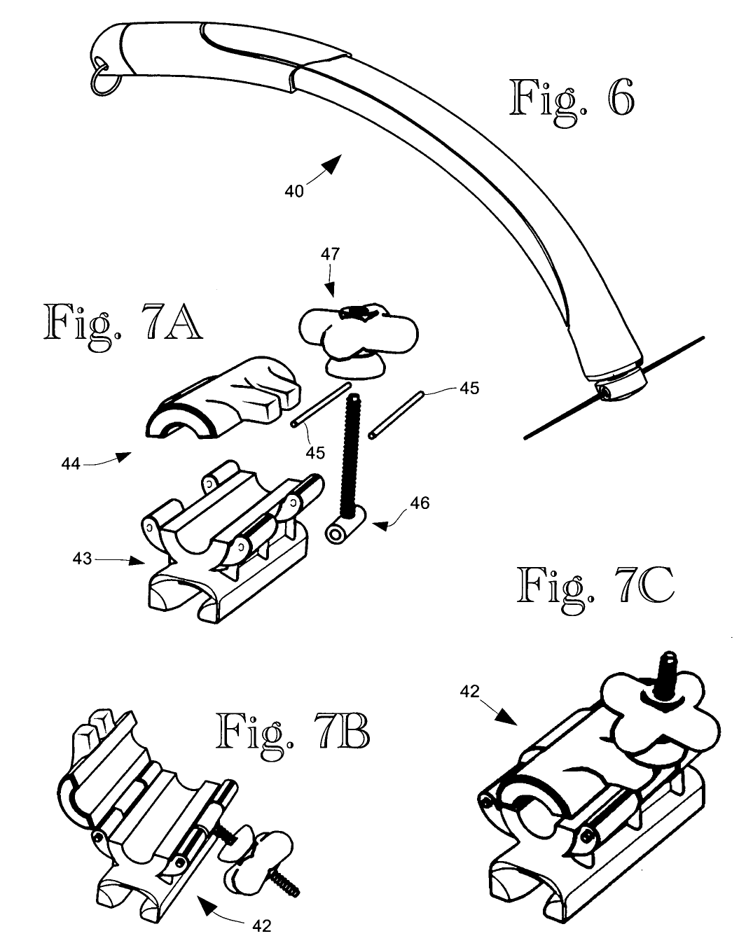

The shape of a trimmer wand may be almost infinitely varied. In the example shown in FIG. 6, a wand takes a form more like a sabre. The angle between the rotating head and the handle, rather than being introduced by a bend near the head as shown in FIG. 1, is introduced by a gentle curve in the housing. About a thirty-degree angle is generally suitable for the trimming products disclosed herein. Holsters or other attachments may be provided for securing a wand to a lawn mower conforming to the selected form. Further in the example of FIG. 6, the housing of this wand is telescoping, providing a reduced storage profile.

A handle or gripping portion of a wand may have incorporated therein texturing, finger recesses, serrations or other shaped features to improve control or comfort. A handle may also include additions, such as a surrounding rubber or foam grip.

The interlock shown in FIGS. 3A and 3B is a good choice where it is not expected that a homeowner will need to relocate the trimmer wand product to a different lawn mower. A quick-release interlock version is depicted in FIGS. 7A, 7B and 7C. The components of this version are depicted in FIG. 7A, which are an interlocking half 43, a clamping half 44, pins 45, threaded stud and bushing 46, and knurled thumbscrew 47. Pins 45 secure the assembled parts of this interlock as shown in FIG. 7B. To use, halves 43 and 44 are positioned around the tubing of a handle, stud 46 is swung between the forked portion of clamping half 44, and thumbscrew is tightened accordingly as depicted in FIG. 7C. Again, this exemplary interlock may ease the transition and mounting of a trimmer between two or more lawn mowers.

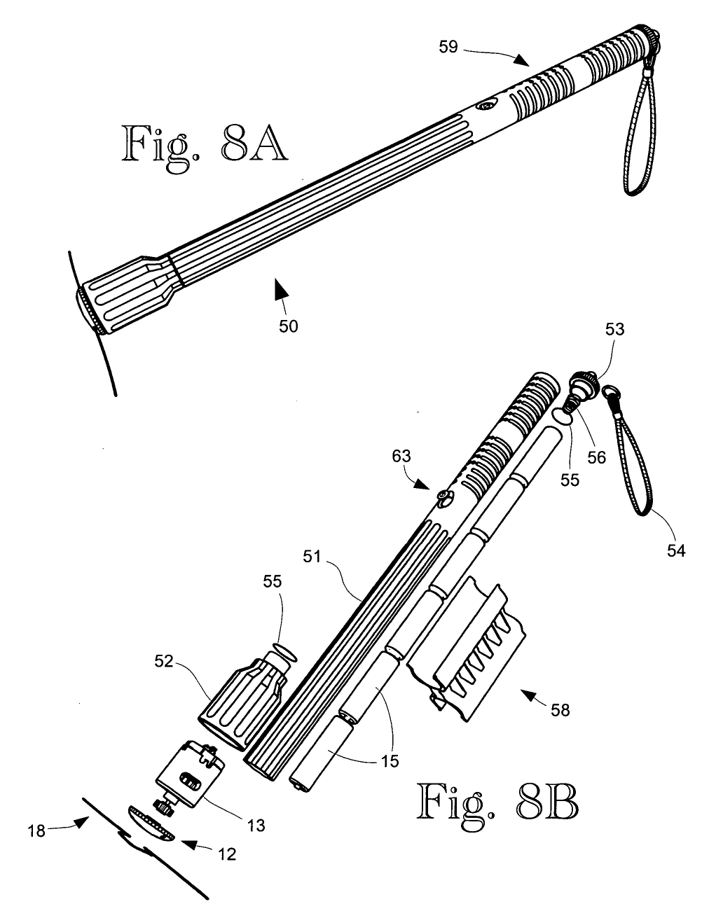

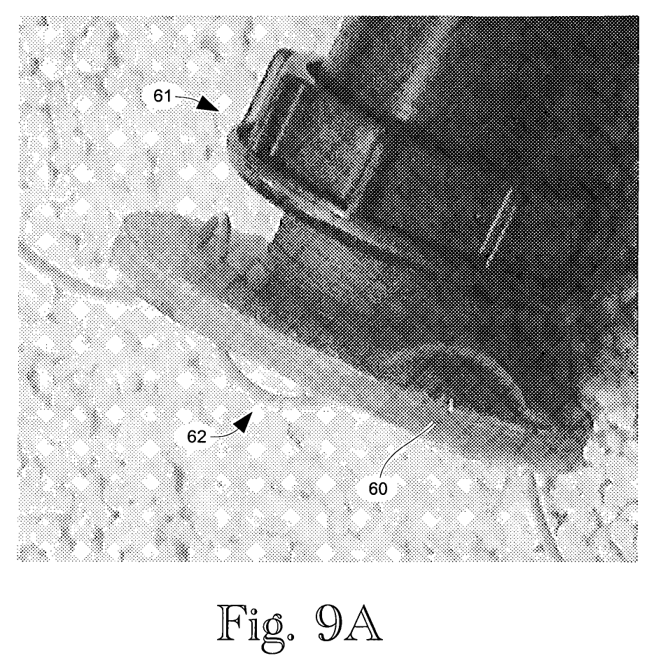

Now turning to FIG. 8A, another trimming wand 50 is depicted, illustrating further possible variations. This example includes no angle between head 12 and gripping portion 59. The housing is fashioned in two parts, which are a tubular battery portion 51 and a wider motor housing 52. In this example portion 51 may be either molded plastic or may be formed from extruded aluminum, bent sheet steel or other metal, providing additional durability. Portion 51 has an inner diameter slightly larger than batteries 15, permitting the batteries to be inserted inside to become serially connected while restricting rattling. Spring contact 56 is incorporated into endcap 53, providing an electrical battery connection. Another contact, not shown, is implemented in motor housing completing a battery circuit. Motor 13 is securable inside housing 52, and is further wired to the battery terminals described above and also to switch 63. Note that if housing 51 and endcap 53 are conductive, these may be used as conductors for the battery/motor circuit. Housing portion 51 may implement inner or outer threads receiving threaded portions of motor housing 52 and endcap 53, as desired. O-rings 55 may be used to resist water penetration, and may also keep the housing parts assembled. Indeed, the construction of a trimmer wand may borrow from techniques for manufacturing flashlights, as desired. 10043] Rather than utilizing an interlock, this example utilizes a securing clip 58. Housing 51 is cylindrical in shape, and clip 58 includes a matching clip. The other side of clip 58 maybe sized for the handlebar of a particular lawn mower, as desired. Also provided with this wand is a hanging loop 54, by which wand 50 may be carried or hanged from a utility hook if desired. The reader may look to the Provisional Application for other devices for securing a trimming wand to a handle; note that other interlocks such as holsters, clips, hooks, elastic ropes and virtually any others that restrain or secure a trimming wand to a lawn mower handle can be used.

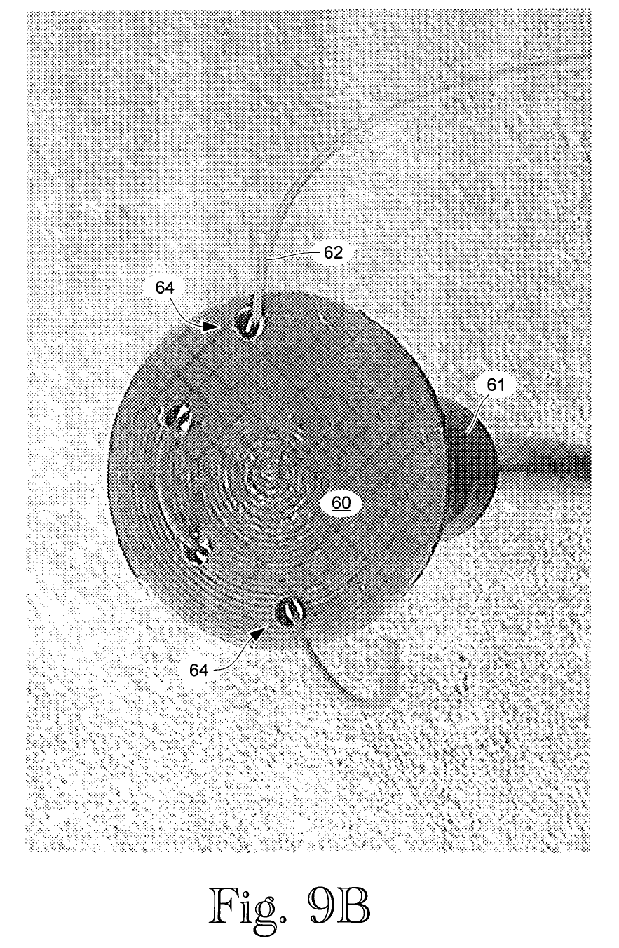

Conventional string trimmer heads utilize a string spool and a mechanism to release additional string as it wears under use. Although such techniques may be employed with a trimmer wand, it may be desired to use a non-spooling trimmer head as depicted in FIGS. 9A and 9B to keep the weight of the product minimal. This trimmer head includes a disc-like portion 60 that rotates against wand body 61. This head utilizes a 10 to 12 inch length of 0.065 length of nylon line 62, threaded through 6 mm holes as shown, leaving about a four-inch length free on both sides. Other operational lengths of string may be utilized for a particular head design and trimming use. The exit holes 64 are placed oppositely around the axis of rotation, thereby providing balance and minimizing vibration from the rotating line ends. This configuration is very good for light-duty use, i.e. where the homeowner does not need to change the line generally more than one time per mow. Now although this method is functionally simple, it may be desired to provide other string retaining devices for securing a length of string to a head, which devices come within the scope of the inventions described herein.

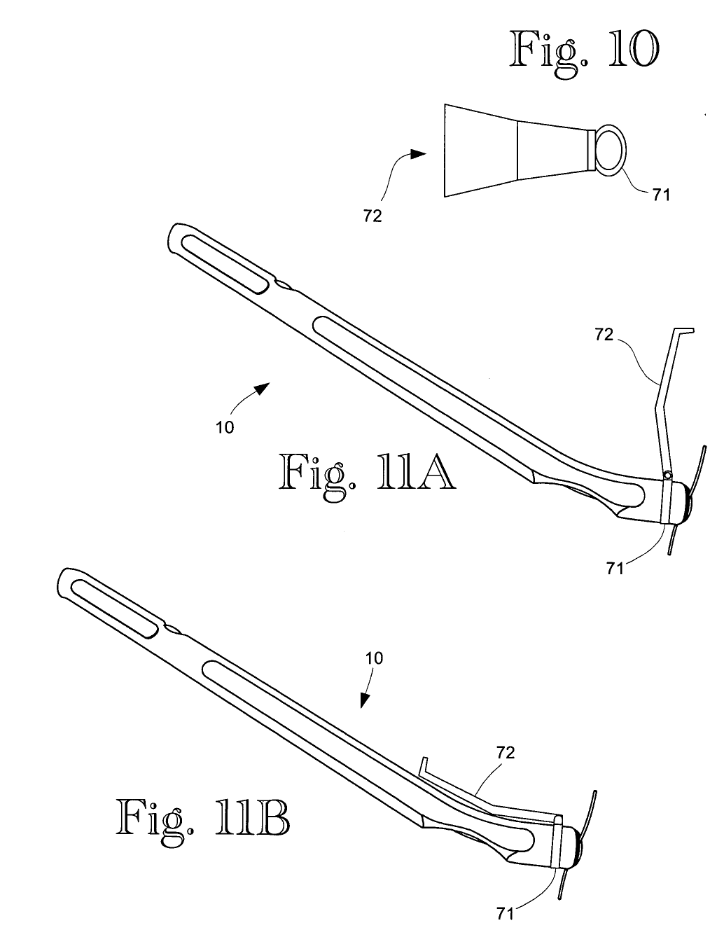

A trimmer wand as disclosed herein may also include a guard, for example the one depicted in FIG. 10. A guard may serve to protect the operator from contact with a rotating string or debris flung out thereby. The guard of FIG. 10 includes an outer arc of about fifteen degrees, with an outer lip extending down about one inch. That guard includes a shield portion 72 and a clamp 71. Shield portion 72 might, for example, be made of molded plastic, or alternatively might be fashioned from sheet metal through a stamping process. Clamp 71 might be metal and susceptible to crimping or otherwise tightening; alternatively clamp 71 might be fashioned from rubber or other elastomer. An attachment for a shield might take any other form, for example integral to a trimmer wand housing.

A guard may also be retractable or fixed. Shown in FIG. 11A is a retractable guard 72 fastened by clamp 71, guard 72 being in an extended (operational) position. Guard 72 may be swung toward wand 10 and thus be positioned in a minimally obstructive position. Guard 72 and clamp 71 may be jointed with a rivet, screw and thumbnut, cam and spring, or any other connection with desirable operational characteristics.

While the present systems, products and methods have been described and illustrated in conjunction with a number of specific configurations, those skilled in the art will appreciate that variations and modifications may be made without departing from the principles herein illustrated, described, and claimed. The present invention, as defined by the appended claims, may be embodied in other specific forms without departing from its spirit or essential characteristics. The configurations described herein are to be considered in all respects as only illustrative, and not restrictive. All changes which come within the meaning and range of equivalency of the claims are to be embraced within their scope.

What is claimed is:

1. A light-duty string trimmer wand attachable to a walk-behind lawn mower, comprising:
a housing;
a handle portion configured for manual grasping;
a rotating head configured to receive and secure a length of trimming string, said rotating head being distally disposed from said handle portion;
an electric motor in communication with said housing and said rotating head, said motor configured to provide rotation under power of said head with respect to said housing;
batteries affixed to said housing;
a switch electrically connected to said batteries and said motor, whereby the powered rotation of said head may be controlled;
a mount securable to the tubular handle of a walk-behind lawn mower, said mount including an interlock whereby said housing may be secured to said trimmer;
wherein said trimmer is independently operable from the lawn mower; and
wherein said trimmer is about 30 to 38 inches in length.

2. A wand according to claim 1, wherein the weight of said wand with batteries is about 5 to 6 pounds or less.

3. A wand according to claim 1, wherein said interlock is a keyed interlock.

4. A wand according to claim 1, wherein said interlock permits said wand to be removed from said mount by sliding the wand out of an interlock channel.

5. A wand according to claim 4, wherein said interlock in at least one installed orientation operates to release when the grasping portion of said wand is pulled generally toward an operator standing behind the tubular handle of the walk-behind mower.

6. A wand according to claim 1, wherein said head is non-spooling and includes a device for securing an operational length of string.

7. A wand according to claim 1, further comprising a retractable guard connected to said housing, said guard retractable to be positioned in a minimally obstructive position.

8. A wand according to claim 1, wherein said batteries are located in said handle.

9. A wand according to claim 1, wherein said trimmer head is angled with respect to said housing and said handle to permit an operator to perform a trimming operation with said head level and away from his body.

10. A walk-behind lawn mower incorporating a light-duty string trimmer wand, comprising:
a mower deck;
an engine mounted to said deck;
a cutting blade coupled to said engine;
a mower handle attached to said mower deck whereby said lawn mower can be controlled;
a mount securable to said handle including an interlock defining an interlock channel;
a housing incorporating a coupling mating to said interlock channel, whereby said housing may be secured to said handle, further whereby said interlock permits said wand to be removed from said mount by sliding the wand out of said interlock channel;
a grasping portion incorporated to said housing;
a rotating head configured to receive and secure a length of trimming string, said rotating head being distally disposed from said grasping portion;
an electric motor in communication with said housing and said rotating head, said motor configured to provide rotation under power of said head with respect to said housing;
batteries affixed to said housing; and
a switch electrically connected to said batteries and said motor, whereby the powered rotation of said head may be controlled.

11. A wand according to claim 10, wherein the weight of said wand with batteries is about 5 to 6 pounds or less.

12. A wand according to claim 10, wherein the weight of said wand including batteries is about 2 to 3 pounds or less.

13. A wand according to claim 10, wherein said interlock is a keyed interlock.

14. A wand according to claim 10, wherein said interlock in at least one installed orientation operates to release when the grasping portion of said wand is pulled generally toward an operator standing behind the tubular handle of the walk-behind mower.

15. A wand according to claim 10, wherein said head is non-spooling and includes a device for securing an operational length of string.

16. A wand according to claim 10, wherein said mount is operable to quick-release from a lawn mower handlebar.

17. A wand according to claim 10, wherein said trimmer head is angled with respect to said housing and said handle to permit an operator to perform a trimming operation with said head level and away from his body.

18. A method of using a light-duty string trimmer wand, comprising the steps of:
providing a lawn mower including a mower deck, an engine mounted to the mower deck, a cutting blade coupled to the engine and a mower handle attached to mower deck whereby the lawn mower can be controlled;
providing a mount secured to the handle, whereby the mount includes an interlock;
providing a light-duty string trimmer wand independently operable from the lawn mower that includes a housing incorporating a coupling mating to the interlock whereby said housing may be secured to the handle, a grasping portion incorporated to the housing, a rotating head distally disposed from the grasping portion and having secured thereto an operational length of trimming string, an electric motor in communication with the housing and the rotating head configured to provide rotation under power of the head with respect to the housing, batteries affixed to said housing, and a switch electrically connected to the batteries and the motor whereby the powered rotation of the head may be controlled;
securing the wand to the lawn mower handle by way of the provided mount;
mowing a lawn;
as obstructions are encountered during said mowing, removing the trimmer wand from the mount, trimming around the obstruction, and replacing the trimmer wand to its mount, all without moving from the immediate vicinity of the lawnmower.

19. A method according to claim 18, wherein the provided mount permits removal of the provided wand by a sliding operation, and whereby said removing and said replacing are performed by a sliding motion.

20. A method according to claim 18, wherein the interlock utilizes a key formed in the housing of the trimmer wand and a channel shaped to accept the key, and wherein said replacing is by aligning the key and the channel.
